(19) United States
(12) Patent Application Publication
(10) Pub. No.: US 2007/0276870 A1
(43) Pub. Date: Nov. 29, 2007

(54) METHOD AND APPARATUS FOR INTELLIGENT MEDIA SELECTION USING AGE AND/OR GENDER

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/749,130

(22) Filed: May 15, 2007

Related U.S. Application Data
(63) Continuation-in-part of application No. 11/282,379, filed on Nov. 18, 2005.
(63) Continuation-in-part of application No. 11/267,079, filed on Nov. 3, 2005.
(63) Continuation-in-part of application No. 11/341,021, filed on Jan. 27, 2006.
(63) Continuation-in-part of application No. 11/298,797, filed on Dec. 9, 2005.
(60) Provisional application No. 60/653,975, filed on Feb. 16, 2005.
(60) Provisional application No. 60/665,291, filed on Mar. 26, 2005.
(60) Provisional application No. 60/648,197, filed on Jan. 27, 2005.
(60) Provisional application No. 60/844,764, filed on Sep. 14, 2006.
(60) Provisional application No. 60/754,387, filed on Dec. 27, 2005.
(60) Provisional application No. 60/649,240, filed on Feb. 1, 2005.

(51) Int. Cl. G06F 17/30

(52) U.S. Cl. 707/104.1

(57) ABSTRACT

Methods and apparatus for automatically selecting a media file for play to a user from a plurality of available media files is disclosed, the selecting being performed with consideration of the age and/or gender of the user. In some embodiments the selecting is performed, at least in part, using an identified age of the user and age-specific popularity data for each of a plurality of media files. In some embodiments the selecting is performed using an identified gender of the user and gender-specific popularity data associated with a plurality of media files. In some embodiments both age and gender are used in combination. In some embodiments an age and/or gender of the user is predicted based upon a history of media file selections and/or preferences of the user.

This application is a continuation-in-part of U.S. patent application Ser. No. 11/282,379 filed Nov. 18, 2005, which claims the benefit of U.S. Provisional Patent Application No. 60/653,975 filed Feb. 16, 2005, both of which are incorporated in their entirety herein by reference.

This application is also a continuation-in-part of U.S. patent application Ser. No. 11/267,079 filed Nov. 3, 2005, which claims the benefit of U.S. Provisional Patent Application No. 60/665,291 filed Mar. 26, 2005 and U.S. Provisional Patent Application No. 60/648,197 filed Jan. 27, 2005, all of which are incorporated in their entirety herein by reference.

This application also claims the benefit of U.S. Provisional Patent Application No. 60/844,764 filed Sep. 14, 2006, which is incorporated in its entirety herein by reference.

This application is also a continuation-in-part of U.S. patent application Ser. No. 11/341,021 filed Jan. 27, 2006, which claims the benefit of U.S. Provisional Patent Application No. 60/754,387 filed Dec. 27, 2005, and which is a continuation-in-part of U.S. patent application Ser. No. 11/298,797 filed Dec. 9, 2005, which claims the benefit of U.S. Provisional Patent Application No. 60/649,240 filed Feb. 1, 2005, all of which are incorporated in their entirety herein by reference.

This application is also related to U.S. patent application Ser. No. 11/285,534 filed Nov. 22, 2005, which claims the benefit of U.S. Provisional Patent Application No. 60/665,291 filed Mar. 26, 2005, U.S. Provisional Patent Application No. 60/651,771 filed Feb. 9, 2005 and U.S. Provisional Patent Application No. 60/648,197 filed Jan. 27, 2005, all of which are incorporated in their entirety herein by reference.

### BACKGROUND OF THE INVENTION

1. Field of the Invention

The present invention relates generally to media players, and more specifically to media players that automatically select musical media to playback based upon user characteristics.

2. Discussion of the Related Art

At the present time a variety of systems have been developed to automatically select a piece of musical media content from a large store of musical media content with the goal of suggesting and/or playing a musical media file to a user that he or she is likely to enjoy. A variety of techniques may be used to intelligently select musical media content based upon the tastes and/or history and/or activities and/or environment of the user. Early examples of such systems have been disclosed by the present inventor in pending U.S. patent application Ser. Nos. 11/267,079, 11/285,534 and 11/533,037 and U.S. Provisional Patent Application Nos. 60/665,291, 60/651,771, 60/720,071 and 60/809,951, all of which are hereby incorporated herein by reference. In some embodiments the automatic selection process is performed locally upon a portable media player, the media player running intelligent selection routines that automatically suggest and/or play a musical media file from among a large store of musical media files such that the user is likely to prefer the selected media file. In other embodiments the automatic selection process is performed remotely upon a media server, the media server running intelligent selection routines that automatically suggest and/or transmit and/or broadcast a musical media file from among a large store of musical media files such that the user is likely to prefer the selected media file. In these ways an intelligent selection routine, either local or upon a remote server, may be operative to automatically suggest and/or play musical media content to a user that the user is likely to prefer. Still, a media player could use other factors to increase the likelihood of selecting a song a user would prefer or to select a song that a user would prefer more than another song.

### SUMMARY OF THE INVENTION

Several embodiments of the invention advantageously address the needs above as well as other needs by providing a media player that is enabled to enhance the musical media selection processes by considering the age and/or gender of the user when automatically selecting musical media for that user. In this way the routines of the present invention have enhanced ability to select musical media for a user that that user is likely to prefer.

In some embodiments, the invention can be characterized as a method of selecting a media file in a media player comprising receiving a request to select a media file; identifying a plurality of candidate media files in response to the request; assigning each of the plurality of candidate media files a score based upon a correlation between gender popularity data associated with each of the plurality of candidate media files and an identified gender of a user; and selecting the media file based at least in part upon the score.

In some embodiments, the invention can be characterized as a method of selecting a media file in a media player comprising receiving a request to select a media file; identifying a plurality of candidate media files in response to the request; assigning each of the plurality of candidate media files a score based upon a correlation between age popularity data associated with each of the plurality of candidate media files and an identified age group of a user; and selecting the media file based at least in part upon the score.

In some embodiments, the invention can be characterized as a method of selecting a media file in a media player comprising receiving a request to select a media file; identifying a plurality of candidate media files in response to the request; assigning each of the plurality of candidate media files a score based at least upon an identified age of a user and an identified gender of the user; and selecting the media file based at least in part upon the score.

In some embodiments, the invention can be characterized as a device to function with a media player comprising one or more processors adapted to: receive a request to select a media file, identify a plurality of candidate media files in response to the request, assign each of the plurality of candidate media files a score based upon a correlation between a user characteristic and characteristic specific popularity data associated with each of the plurality of candidate media files, and select the media file based at least in part upon the score.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a diagram illustrating an exemplary media player of the present invention;

FIG. 2 illustrates an exemplary system of the present invention;

FIG. 3a illustrates a flow diagram, consistent with the invention, for selecting media files based in part on Gender information;

FIG. 3b illustrates a flow diagram, consistent with the invention, for selecting media files based in part on Age information.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

The present invention addresses these and other needs by using an identified Age and/or identified Gender of the user of a media player to better select a media file for that user from a plurality of available media files. One aspect of the present invention is directed to a method of selecting a media file from a set of media files based at least in part upon an identified Age of the user. Each media file is assigned a score based in whole or in part upon a degree of correlation between an Identified Age Group for the user and Age Popularity Data that is relationally associated with the media file, one or more media files being selected from the set of media files based on the assigned scores. In some embodiments the Identified Age Group of the user includes an annual age or a range of annual ages. For example, the identified Age Group may include the range of ages 12 to 15 years old. In some embodiments the Identified Age Group may also include an Age Correlation Factor that is stored and indicates the degree of statistical relevance that age has for the particular user. In one such embodiment the Age Correlation Factor is a number between 0 and 1 that indicates a degree of statistical relevance that age has to predicting the media file preference of that user, the larger the number the more statistical relevance. For example, in some users age may be highly relevant in predicting the media files that the user may prefer. For such a user, the Age Correlation Factor may be set to 0.88 for example. In other users, age may be mildly relevant in predicting the media files that a user may prefer. For such a user the Age Correlation Factor may be set to 0.24 for example. In other embodiments, no Age Correlation Factor is used.

Another aspect of the present invention is directed to a method of selecting a media file from a set of media files based at least in part upon an identified Gender of the user. Each media file is assigned a score based in whole or in part upon a degree of correlation between an Identified Gender for the user and Gender Popularity Data that is relationally associated with the media file, one or more media files being selected from the set of media files based on the assigned scores. In some embodiments the Identified Gender of the user is a single variable indicating male or female. In other embodiments the Identified Gender may also include a Gender Correlation Factor that indicates the degree of statistical relevance that gender has for predicting the media file preference for that particular user. In one such embodiment the Gender Correlation Factor is a number between 0 and 1 that indicates a degree of statistical relevance that gender has to media file preference for that user. For example, in some users gender may be highly relevant in predicting the media files that the user may prefer. For such a user, the Gender Correlation Factor may be set to 0.90 for example. In other users, gender may be mildly relevant in predicting the media files that a user may prefer. For such a user the Gender Correlation Factor may be set to 0.27 for example. In other users, gender may be inversely correlated with the typically predicted media files that a user may prefer. For such a user the Gender Correlation Factor may be set to −0.33 for example, indicating that the user's preference is mildly correlated to the opposite gender indicated by Identified Gender data. In other embodiments, no Gender Correlation Factor is used.

Another aspect of the present invention is directed to a method of selecting a media file from a set of media files based at least in part upon an identified Age and Gender of the user. Each media file is assigned a score based in whole or in part upon a degree of correlation between an Identified Age Group for the user and Age Popularity Data that is relationally associated with the media file AND upon a degree of correlation between an Identified Gender for the user and Gender Popularity Data that is relationally associated with the media file, one or more media files being selected from the set of media files based on the assigned scores. In this way the combined affect of a users Age and Gender upon predicted media file preference may be used to better select a media file for a user from a plurality of media files. In other embodiments, weighting factors are used such that Age and Gender correlations have differing amounts of affect upon media file selection. In some embodiments, the user belonging to certain age groups has a larger affect upon his or her predicted preference in media files as compared to the user belonging to other age groupings. For example, in certain embodiments the younger the age grouping that a user belongs to, the more effect that age correlation has upon the predicted preference in media files.

Another aspect of the present invention is directed to a method for adjusting the Identified Age Group and/or Age Correlation Factor for a user based upon a history of media file preferences and a correlation with the media files preferred by other users of certain ages and/or age groups. In this way a user may be assigned an Identified Age Group that is different from his or her chronological age. Such methods are useful in providing better selecting media files for users who may be behaviorally more similar to users who are older or younger than themselves.

Another aspect of the present invention is directed to a method for adjusting the Gender and/or the Correlation Factor for a user based upon a history of media file preferences and a correlation with the media files preferred by other users of certain gender. In this way a user may be assigned an Identified Gender that is different from his or her biological gender. Such methods are useful in providing better media file selections for users who may be behaviorally more similar to users who are of the opposite gender than themselves.

Another aspect of the present invention is directed to a method of predicting the gender of a particular user based at least in part upon correlations between that user's media file selections and stored Gender Popularity Data for a plurality of media files.

Another aspect of the present invention is directed to a method of predicting the age or age grouping of a particular user based at least in part upon correlations between that user's media preferences and stored Age Popularity Data for a plurality of media files.

In some embodiments, a request for a media file is received and a list of responsive media files is identified. The request for a media file may be initiated by a user or may be automatically initiated, for example as a result of a currently media file being listened to completing play or nearing the completion of play. Regardless of how it is initiated, an event occurs within a media player and/or media server that requires a media file to be selected for a user from a plurality of available media files. The media file may be selected and suggested to the user, the user having the ability to accept or reject the suggestion. Or the media file may be automatically played to the user, the user not being provided with an acceptance or rejection capability. Either way, a media file is selected from among a plurality of available media files for suggestion and/or play to the user. The present invention relates to methods for performing that selection based at least in part upon an identified Age and/or identified Gender of the user. Details of system architecture, media selection processes, and media acceptance and rejection processes are disclosed in aforementioned co-pending U.S. patent application Ser. Nos. 11/267,079, 11/285,534 and 11/533,037, and U.S. Provisional Patent Application Nos. 60/665,291, 60/651,771, 60/720,071 and 60/809,951, all of which are hereby incorporated herein by reference. The present disclosure is focused on methods of using Age and/or Gender in the selection process.

Once a request has been made to select a media file from a plurality of available media files, an Identified Gender is also accessed, either from a store of data in local or remote storage, or through a query to the user prior to or during the selection process. In some embodiments, for example, the Identified Gender data includes data indicating if the user has been identified as male or female. In another embodiment, for example, the Identified Gender data also includes a Gender Correlation Factor that indicates the degree of statistical relevance that gender has for predicting the media file preference for that particular user. In one such embodiment the Gender Correlation Factor is a number between 0 and 1 that indicates a degree of statistical relevance that gender has to media file preference for that user. For example, in some users gender may be highly relevant in predicting the media files that the user may prefer. For such a user, the Gender Correlation Factor may be set to 0.90 for example. In other users, gender may be mildly relevant in predicting the media files that a user may prefer. For such a user the Gender Correlation Factor may be set to 0.27 for example. In other users, gender may be inversely correlated with the typically predicted media files that a user may prefer. For such a user the Gender Correlation Factor may be set to −0.33 for example, indicating that the user's preference is mildly correlated to the opposite gender indicated by Identified Gender data. In other embodiments, no Gender Correlation Factor is used.

In addition to the steps above, some preferred embodiments of the current invention also include additional methods and systems for storing and processing data related to media file popularity, said data referred to generally as popularity data. Typically popularity data includes information about a media file that describes how many users have accessed (i.e. listened to) the media file (perhaps over a period of time) and/or how often users access (i.e. listen to) the media file (perhaps over a period of time). Alternately the popularity data is based upon subjective rating information provided by users who have listened to or are otherwise familiar with a media file. Thus either by tracking the number of users, frequency of users, and/or ratings provided by users, who listened to or otherwise experienced a particular media file, popularity data indicates how popular that media file as compared to other media files for which similar data is stored. Thus popularity data is an indication of how likely a particular media file is to be preferred by a user based upon how many or how often other users listen to it and/or based upon how it is rated by other users.

In some embodiments, Gender Popularity Data may be employed. Gender Popularity Data not only represent how popular a media file is (based upon previous users who have listened to and/or rated the media file), but also correlates the Identified Gender of those users who have accessed and/or rated the media file in the past. In this way the power of popularity data can be substantially expanded, recording not just how popular a particular media file is, but how popular it is among a particular gender of users.

In one particular embodiment, Gender Popularity Data is represented as a single variable that indicates the percentage of users who have recently listened to and/or positively rated the media file that are of a particular gender. Because there are only two genders, MALE or FEMALE, either may be chosen as the basis for this variable with the understanding that the remaining percentage of users are of the other gender. For example, a single variable PERCENT_MALE may used that indicates the percentage of users who have recently listened to and/or positively rated a particular media file who are male. If this value was computed as 64% it can be inferred that the remaining 36% of visitors are female. In this way a single variable can represent the percentage of male and female users who have recently listened to and/or positively rated the given media file. The PERCENT_MALE variable may be computed based upon the number of listeners, the frequency of listeners, and/or the number or frequency of positive ratings for that musical media file. The PERCENT_MALE variable may be computed over a particular period of time, for example over the last 24 hours, over the last seven days, or over the last six months. In some embodiments multiple variables are computed using the number of listeners, the frequency of listeners, and/or mean subjective rating values provided by users during a particular period of time. Because these values are tracked independently for each gender of users, this data indicates the popularity of the musical media file among male users as well as the popularity of the musical media file among female users.

By determining and storing Gender Popularity Data as described in the paragraphs above, the methods and systems disclosed herein can further optimize the selection of a media file from a plurality of media files for a particular user based at least in part upon that user's Identified Gender. For example if a media file is being selected for a user and that user has Identified Gender data that identifies him or her as MALE, the selection of a media file to be suggested and/or played to that user may then be based in whole or in part upon the popularity of that media file among other male users, as identified by the Gender Popularity Data for that media file. In this way, the Identified Gender data of the user can be used in conjunction with Gender Popularity Data to better select a media file for that user from among a plurality of media files.

In some embodiments, once a request has been made to select a media file from a plurality of available media files, an Identified Age Group is also accessed, either from a store of data in local or remote storage, or through a query to the user prior to or during the selection process. In some embodiments, for example, the Identified Age Group data includes data indicating an annual age of the user or an annual age range for the user. For example, the Identified Age Group data may include data indicating that the user's age has been identified to fall within one of the following ranges: under 7 years old, 8 to 12 years old, 13 to 15 years old, 16 to 18 years old, 19 to 25 years old, 26 to 35 years old, 36 to 45 years old, 46 to 60 years old, and over 60 years old. In another embodiment, for example, the Identified Age Group data also includes an Age Correlation Factor that indicates the degree of statistical relevance that age has for predicting the media file preference for that particular user. In one such embodiment the Age Correlation Factor is a number between 0 and 1 that indicates a degree of statistical relevance that age has to media file preference for that user. For example, in some users age may be highly relevant in predicting the media files that the user may prefer. For such a user, the Age Correlation Factor may be set to 0.88 for example. In other users, age may be mildly relevant in predicting the media files that a user may prefer. For such a user the Age Correlation Factor may be set to 0.24 for example. In other embodiments, no Age Correlation Factor is used.

In addition to the steps above, some preferred embodiments of the current invention also include additional methods and systems for storing and processing a new form of popularity data referred to herein as Age Popularity Data. Age Popularity Data not only represent how popular a media file is (based upon previous users who have listened to and/or rated the media file), but also correlates the Identified Age Group of those users who have accessed and/or rated the media file in the past. In this way the power of popularity data can be substantially expanded, recording not just how popular a particular media file is, but how popular it is among a particular ages or age groups of users.

By determining and storing Age Popularity Data as described in the paragraph above, the methods and systems disclosed herein can further optimize the selection of a media file from a plurality of media files for a particular user based at least in part upon that user's Identified Age Group. For example if a media file is being selected for a user and that user has Identified Age Group data that identifies him or her as 19 to 25 years old, the media file that is automatically suggested and/or played to that user may be based in whole or in part upon the popularity of that media file among other users in the 19 to 25 year old age grouping, as identified by the Age Popularity Data for that media file. In this way, the Identified Age Data of the user can be used in conjunction with Age Popularity Data to better select a media file for that user from among a plurality of media files.

In some embodiments of the present invention, both Identified Gender for the user and Identified Age Group for the user are used at least in part to select a media file from a plurality of media files for automatic suggestion and/or play to that user. More specifically, Identified Gender data is used in combination with Gender Popularity Data and Identified Age Group data is used in combination with Age Popularity Data in order to better automatically select a media file from a plurality of media files that the given user is likely to prefer. The process is generally performed wherein each media file in the plurality of media files is assigned a score based in whole or in part upon a degree of correlation between an Identified Gender for the user and Gender Popularity Data that is relationally associated with the media file AND a degree of correlation between an Identified Age Group for the user and Age Popularity Data that is relationally associated with the media file. A media file is then selected form among the plurality of media files based at least in part upon the assigned scores. In this way the combined affect of a users Age and Gender upon predicted media file preference may be used to better select a media file from among a plurality of media files. In some such embodiments Age and Gender correlations are equally weighted in their affect upon media file selection. In other embodiments, weighting factors are used such that Age and Gender correlations have differing amounts of affect upon media file selection. In some embodiments, the user belonging to certain age groups has a larger affect upon his or her predicted preference in media files as compared to the user belonging to other age groupings. For example, in certain embodiments the younger the age grouping that a user belongs to, the more effect that age correlation has upon his or preference in media files.

Another aspect of the present invention is directed to a method for adjusting the Identified Age Group and/or Age Correlation Factor for a user based upon a history of media file preferences for that user and a correlation with the media files preferred by other users of certain ages and/or age groups. In this way a user may be assigned an Identified Age Group that is different from his or her chronological age. Such methods are useful in providing better musical media selections for users who may be behaviorally more similar to users who are older or younger than themselves.

Another aspect of the present invention is directed to a method for adjusting the Gender and/or the Correlation Factor for a user based upon a history of media file preferences for that user and a correlation with the media files preferred by other users of certain gender. In this way a user may be assigned an Identified Gender that is different from his or her biological gender. Such methods are useful in providing better musical media selections for users who may be behaviorally more similar to users who are of the opposite gender than themselves.

Another aspect of the present invention is directed to a method of predicting the gender of a particular user based at least in part upon correlations between that user's media file preferences and stored Gender Popularity Data for a plurality of media files. Another aspect of the present invention is directed to a method of predicting the age or age grouping of a particular user based at least in part upon correlations between that user's media file preferences and stored Age Popularity Data for a plurality of media files.

### A. HARDWARE EMBODIMENTS

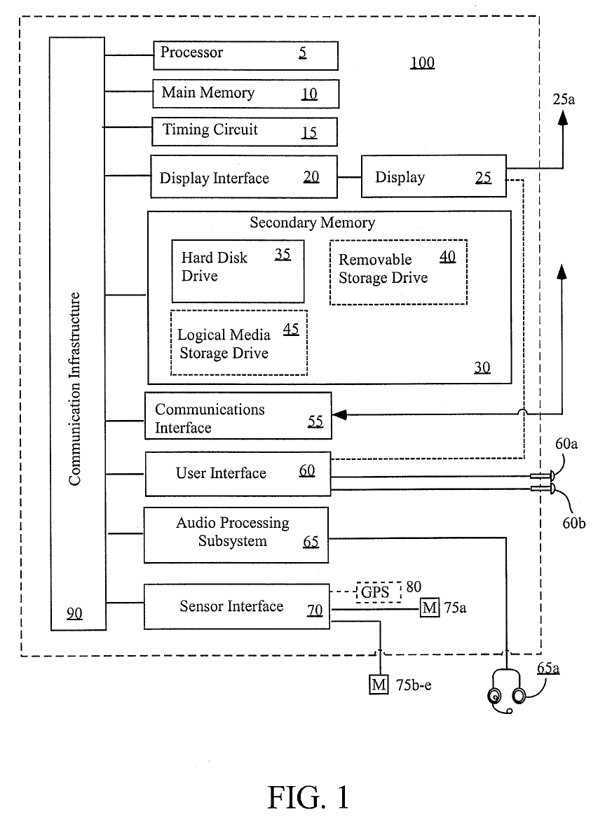

As described previously the present invention may be implemented fully upon a portable media player or may be implemented using a media client device that operates in coordination with a remote media server. FIG. 1 provides a generalized and exemplary block diagram of a portable media player 100 as is described in the various exemplary embodiments. This media player may be used to run the full system of the present invention as a portable unit that implements the methods of the present invention, or may be used as a client in coordination with a remote media server that implements the methods of the present invention. Either way, the portable media player generally includes common components for accessing and playing media content to its user. In this example embodiment, media player 100 includes a communications infrastructure 90 used to transfer data, memory addresses where data items are to be found and control signals among the various components and subsystems associated with or coupled to the portable media player 100. A processor 5 is provided to interpret and execute logical instructions stored in the main memory 10.

The main memory 10 is the primary general purpose storage area for instructions and data to be processed by the central processor 5. The main memory 10 is used in its broadest sense and includes RAM, EEPROM and ROM. A timing circuit 15 is provided to coordinate activities within the portable media player 100 in near real time. The unit may also include one or more internal sensors 75A, 80 and/or coupled to a sensor interface 70 which receives sensor data from one or more external sensors 75B-E. These sensors may be used in part to support the media selection process as disclosed in the aforementioned co-pending patent applications. For example, sensor 80 may be a geospatial locative sensor that detects the current location of the portable media player as it is moved about the real world by its user. In many preferred embodiments sensor 80 is a Global Positioning System (GPS) 120 for use in tracking the location of portable media player in real time. In some embodiments the user's location is used in part in the selection of media content for that user.

A display interface 20 is provided to drive one or more displays 25, 25A associated with the portable media player 100. The display interface 20 is electrically coupled to the communications infrastructure 90 and provides signals to the display(s) 25, 25A for visually outputting both graphics and alphanumeric characters. In an exemplary embodiment, a display 25 may be incorporated into the housing of the portable media player 100 and/or may be another separate device worn by the user 25A.

The display 25 may also be coupled to a user interface 60, 60A, 60B for interacting with software being executed by the processor 5. The display interface 20 may include a dedicated graphics processor and memory to support the displaying of graphics intensive media. The internal display 25 may be of any type (e.g., cathode ray tube, gas plasma) but in most circumstances will usually be a solid state device such as liquid crystal display. The external display 25A necessitates a lightweight construction, generally an LCD screen. The display may be used, for example, to display the titles of media suggestions that are automatically made by the present invention and presented to the user for acceptance or rejection. Such acceptance or rejection methods are disclosed in the aforementioned co-pending patent applications.

A secondary memory 30 is provided which houses retrievable data storage units such as a hard disk drive 35, an optional removable storage drive 40, and/or an optional logical media storage drive 45. One skilled in the art will appreciate that the hard disk drive 35 may be replaced with flash memory. The secondary memory 30 may be used to store a plurality of media files, including but not limited to a plurality of digital songs, a plurality of digital images, a plurality of personal photographs, a plurality of video files, and/or a plurality of other media items.

The optional removable storage drive 40 may be a replaceable hard drive, optical media storage drive or a solid state flash RAM device. Both the optional removable storage drive 40 and optional logical media storage drive 45 may include a flash RAM device, an EEPROM encoded with playable media, or optical storage media (CD, DVD). The optional removable storage drive 40 may be connected directly to the communications infrastructure 90 or in alternate exemplary embodiments, via a communications interface 55.

The communications interface 55 subsystem is provided which allows for electrical connection of peripheral devices to the communications infrastructure 90 including, serial, parallel, USB, Firewire™ connectivity and proprietary communications connections usually associated with a docking cradle (not shown.)

The communications interface 55 also facilitates the remote exchange of data and synchronizing signals between the portable media player 100 and other devices in processing communications 85 with the portable media player 100. The other devices may include one or more external sensors 75B-E that are disposed elsewhere upon the user's body. The other devices may also include a wireless headset 65A, a remote display 25A, another portable media player and/or a remote server. The remote server may be a media server that performs the age and/or gender based selection methods of the present invention and then sends suggestions and/or broadcasts media content to media player 100 based upon the resulting media file selected by the selection methods. In some embodiments the age and/or gender based selection methods are performed through coordinated activity media player 100 and the remote media server.

The communications interface 55 is envisioned to include a radio frequency transceiver normally associated with wireless computer networks for example, wireless computer networks based on BlueTooth™ or the various IEEE standards 802.11x, where x denotes the various present and evolving wireless computing standards, for example WiMax 802.16 and WRANG 802.22. Alternately, digital cellular communications formats compatible with for example GSM, 3G and evolving cellular communications standards. Both peer-to-peer (PPP) and client-server models are envisioned for implementation of the invention. In a third alternative exemplary embodiment, the communications interface 55 may also include hybrids of computer communications standards, cellular standards and evolving satellite radio standards.

A user interface 60 is provided as the means for a user to control and interact with the portable media player 100. The user interface 60 provides interrupt signals to the processor 5 that may be used to interpret user interactions with the portable media player 100. For purposes of this specification, the term user interface 60, 60A, 60B includes the hardware and operating software by which a user interacts with the portable media player 100 and the means by which the portable media player 100 conveys information to the user. The user interface 60 may be used in conjunction with the display(s) 25, 25A in order to simplify interactions with the portable media player 100 when the user is performing physical activities. The user interface 60 employed on the portable media player 100 may include a pointing device (not shown) such as a mouse, thumbwheel or track ball, an optional touch screen (not shown); one or more push-button switches 60A, 60B; one or more sliding or circular potentiometer controls (not shown) and one or more switches (not shown).

An audio processing subsystem 65 is provided to output analog audio to the user's headset 65A and input commands, messages and other verbal information from a microphone attached to the headset 65A. The audio processing subsystem is generally known in the relevant art, for example, personal computer sound cards.

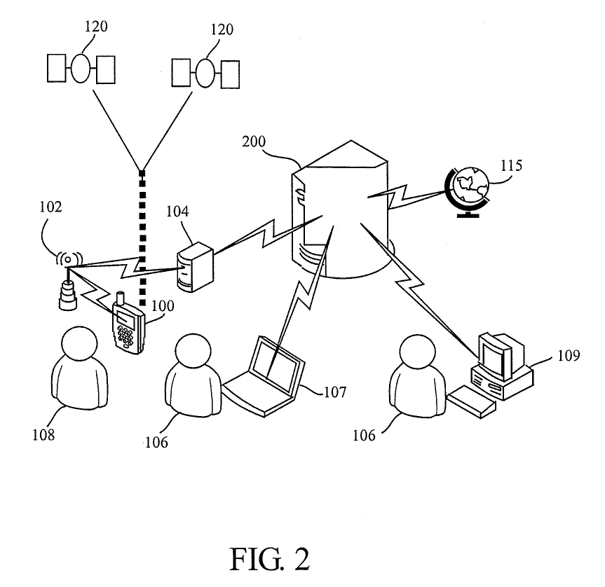

As illustrated in FIG. 2, the present invention may be implemented as a managed service (e.g., in an ASP model) using a media server (MS) 200, which is connected or connectable to one or more networks. For illustrated purposes, the media server 200 is illustrated as a single machine, but one of ordinary skill will appreciate that this is not a limitation of the invention. More generally, the service is provided by an operator using a set of one or more computing-related entities (systems, machines, processes, programs, libraries, functions, or the like) that together facilitate or provide the inventive age and/or gender media selection functionality described herein. In a typical implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, ASP) and a set of applications or processes (e.g., Java applets or servlets, linkable libraries, native codes or the like, depending on platform), that provide the functionality of a given system or subsystem. The service may be implemented in a standalone server, or across a distributed set of machines. Typically, a server connects to the publicly-routable Internet 115, a corporate intranet, a private network, or any combination thereof, depending on the desired implementation environment. As illustrated FIG. 2, the server 200 may be in communication with a mobile service provider (MSP) 102 through a gateway, such as SMS gateway 104.

As also illustrated in FIG. 2, one or more users 106, 108 register for the service, typically by using a client machine which may be the portable media player 100 or some other machines such as a laptop 107 or desktop computer 109. When a desktop computer is used, registration is initiated by an end user opening a Web browser to the operator's Web site registration page (or set of registration pages). When a portable media player is used, registration may be initiating through a mini-browser or other similar interface. These techniques are merely representative, as any convenient technique (including, without limitation, email, filling out and mailing forms, and the like) may be used. Thus, in the illustrated embodiment, users register with the server 200 (or set of servers) either through Internet connections from personal computers, or via remote registration through a mobile device.

The registration process may include, for example, the user entering his or her age or date of birth. The server may then store the age and/or date of birth of the user in a User Profile Database such that the user's age and/or age grouping may be employed at least in part when making automatic media selections for that user. The registration process may include, for example, the user entering his or her gender. The server may then store the gender of the user in a User Profile Database such that the user's gender may be employed at least in part when making automatic media selections for that user. In this way the server 200 may include a User Profile Database which stores age and/or gender information for a plurality of users, the date for each user being indexed by a unique ID associated with that user. In this way the server 200 may be operative to access Identified Age and/or Identified Gender data for each user that selects, rates, and/or requests media from the server. In this way the server may be operative to compiles and store Age Popularity Data and Gender Popularity Data for each of a plurality of musical media files.

In some embodiments media server 200 may perform age and/or gender based media selection for a user who accesses the server using portable media player 100. The selection may be performed by server 200 and communicated to media player 100. In an alternate embodiment the media player 100 may perform the selection process, but may access Age Popularity Data and/or Gender Popularity Data stored upon server 200 for a plurality of users.

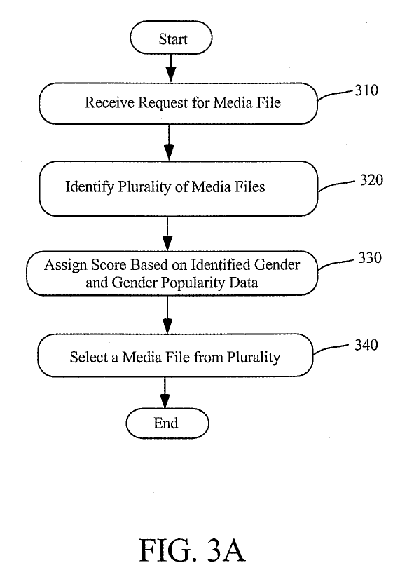

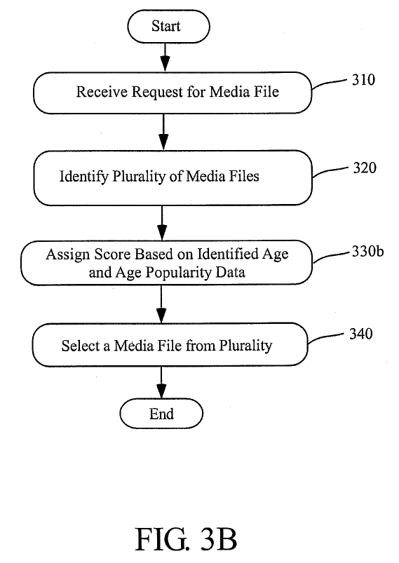

The present invention generally includes at least one Media Selection Application that uses, at least in part, the age and/or gender of a user when selecting a musical media file for suggestion or play to that user from among a plurality of available musical media files. The Media Selection Application, either running wholly upon the portable media player, wholly upon the media server, or in distributed combination with routines running upon both the media player and media server, is operative to select a media file for suggestion or play to a user based at least in part upon the age and/or gender of that user in combination with Age Popularity Data and/or Gender Popularity Data for each of a plurality of media files. The steps of example such software methods are described with respect to FIG. 3a and FIG. 3b below.

### B. PROGRAM FLOW

FIG. 3a illustrates a flow diagram, consistent with the invention, for selecting a media file from among a plurality of media files for a user, based at least in part upon an Identified Gender related to that user and Gender Popularity Data related to each of a plurality of media files that are under consideration for selection. It should be noted that the plurality of media files may be identified based upon other selection considerations, for example taste parameters, history parameters, location parameters, and environmental parameters for the user. At step 310, a request for a media file is received, triggering the routines of the present invention to begin the selection process. At step 320, a plurality of media files for consideration are identified. This set of candidate media files may be identified in a variety of ways. It may, for example, be the full set of media files available for play at a particular time. Or it may be a subset of the media files available for play. Once this set of candidate media files has been determined, it is necessary to select a media file for suggestion or play to the user. Consistent with the invention, this may be achieved by employing Identified Gender data, in whole or in part. Consistent with the invention this may be achieved also by employing Gender Popularity Data, in whole or in part. In the particular embodiment represented by FIG. 3a, this is achieved by employing both Identified Gender data and Gender Popularity Data for each of a plurality of media files in said candidate set, in whole or in part.

As shown at step 330, scores are assigned to each media file based upon how well the Gender Popularity Data for a particular media file correlates with the Identified Gender data of the user. The scores may be absolute in value or relative to the scores for other media files. The scores are weighed based upon the level or degree of correlation determined. For example, a media file that has Gender Popularity Data that shows high popularity by male users as compared to female users will be determined to correlate strongly with a user who has an Identified Gender as male. Alternately, a media file that has Gender Popularity Data that shows low popularity by male users as compared to female users will be determined to correlate weakly with a user who has an Identified Gender as male. In this way, a higher score can be assigned to a media file that shows a strong correlation between Gender Popularity Data and Identified Gender as compared to a media file that shows weaker correlation between Gender Popularity Data and Identified Gender. In addition, a Gender Correlation Factor may be taken into account in the computation of such scores. For example, a user that has a high Gender Correlation Factor may have a greater difference in computed scores based upon the correlation between Gender Popularity Data and Identified Gender as compared to a user who has a low Gender Correlation Factor value associated with him or her. In this way the media files may be scored based upon the correlation between Identified Gender of the user and the Gender Popularity Data for the media file, with optional consideration of a Gender Correlation Factor that represents the predictive value of gender on musical media preference for the particular user.

As a means of further example, in one exemplary embodiment a media file is required by a user who is identified as MALE (i.e. Identified Gender=MALE). A plurality of media files are considered. One media file has Gender Popularity Data that indicates that the percentage of male users with a favorable opinion of the file (i.e. PERCENT_MALE) is computed as 81%. Another particular media file has Gender Popularity Data that indicates that the percentage of male users with a favorable opinion is 26%. Thus the first aforementioned media file has a strong correlation between Gender Popularity Data and the Identified Gender of the user and the second aforementioned media file has a weak correlation between the Gender Popularity Data and the Identified Gender of the user. The first media file is therefore assigned a higher score in step 330 than the second media file.

Thus returning attention to FIG. 3a, the process of assigning a score at step 330 is performed based upon based the Gender Popularity Data and Identified Gender data. The Gender Popularity Data and Identified Gender data may be maintained at server 200. Alternately the Gender Popularity Data may be maintained upon server 200 and the Identified Gender data may be maintained upon client media player 100. Alternately both Gender Popularity Data and Identified Gender data may be maintained upon client media player 100. Thus a variety of architectures are possible.

At step 340, at least one media file is selected from the set of candidate media files based at least in part upon on the assigned scores. The media file may be selected based entirely on the scores derived from Gender Popularity Data of the retrieved media files and the Identified Gender. Alternatively, the media file may be selected based on the assigned scores in combination with other factors. For example, the media files may be organized based on the assigned scores combined with user taste information, user listening history information, user location information, or user environment information.

In addition, the relative importance of the gender score with respect to the other factors used in selection the media files is a variable that may be set, assigned, or derived.

In some preferred embodiments of the present invention, the relative importance of gender as compared to other factors used in selection the media file is based in whole or in part upon a Gender Correlation Factor value that is relationally associated with the user. In such embodiments the affect that gender score has upon media preference as compared to the affect that other factors have is dependent upon the Gender Correlation Factor, the higher the Gender Correlation Factor, the greater the affect that gender has upon automatic media selection as compared to other factors used in selection.

Referring next to FIG. 3b, an example flow diagram is presented as one method for selecting media files based on both Identified Age Group related to the user for whom a media item is being selected and Age Popularity Data related to the media files that are being considered for selection. It should be noted that the plurality of media files may be identified based upon other selection considerations, for example taste parameters, history parameters, location parameters, and environmental parameters for the user. At step 310, a request for a media file is received, triggering the routines of the present invention to begin the selection process. At step 320, a plurality of media files for consideration are identified. This set of candidate media files may be identified in a variety of ways. It may, for example, be the full set of media files available for play at a particular time. Or it may be a subset of the media files available for play. Once this set of candidate media files has been determined, it is necessary to select a media file for suggestion or play to the user. Consistent with the invention, this may be achieved by employing Identified Age data, in whole or in part. Consistent with the invention this may be achieved also by employing Age Popularity Data, in whole or in part. In the particular embodiment represented by FIG. 3b, this is achieved by employing both Identified Age data and Age Popularity Data for each of a plurality of media files in said candidate set, in whole or in part.

As shown at step 330B, scores are assigned to each media file based upon how well the Age Popularity Data for a particular media file correlates with the Identified Age data of the user. The scores may be absolute in value or relative to the scores for other media files. The scores are weighed based upon the level or degree of correlation determined. For example, a media file that has Age Popularity Data that shows high popularity by users in the 18 to 25 age group as compared to other age group users will be determined to correlate strongly with a user who has an Identified Age as being within the 18 to 25 age group. Alternately, a media file that has Age Popularity Data that shows low popularity by users in the 18 to 25 age group as compared to other users will be determined to correlate weakly with a user who has an Identified Age as being within the 18 to 25 age group. In this way, a higher score can be assigned to a media file that shows a strong correlation between Age Popularity Data and Identified Age Group as compared to a media file that shows weaker correlation between Age Popularity Data and Identified Age Group. In addition, an Age Correlation Factor may be taken into account in the computation of such scores. For example, a user that has a high Age Correlation Factor may have a greater difference in computed scores based upon the correlation between Age Popularity Data and Identified Age as compared to a user who has a low Age Correlation Factor value associated with him or her. In this way the media files may be scored based upon the correlation between Identified Age Group of the user and the Age Popularity Data for the media file, with optional consideration of a Age Correlation Factor that represents the predictive value of age on musical media preference for the particular user.

As a means of further example, in one exemplary embodiment a media file is required by a user who is identified as Under 8 Years Old (i.e. Identified Age Group=Under 8 Years Old). In response to this request for a media file, a set of candidate media files is identified. One particular media file in the plurality of media files has Age Popularity Data that indicates that the percentage of users who are in the age group Under 8 Years Old who have a favorable opinion of the media file is 65%. Another particular media file has Age Popularity Data that indicates that the percentage of users who are in the age group Under 8 Years Old who have a favorable opinion of the media file is 9%. Thus the first aforementioned media file has a strong correlation between Age Popularity Data and the Identified Age Group of the user and the second aforementioned media file has a weak correlation between the Age Popularity Data and the Identified Age Group of the user. The first media file is therefore assigned a higher score in step 330B than the second media file.

Thus returning attention to FIG. 3b, the process of assigning a score at step 330B is performed based upon based the Age Popularity Data and Identified Age Group of the user. The Age Popularity Data and Identified Age data may be maintained at server 200. Alternately the Age Popularity Data may be maintained upon server 200 and the Identified Age Group data may be maintained upon client media player 100. Alternately both Age Popularity Data and Identified Age data may be maintained upon client media player 100. Thus a variety of architectures are possible.

At step 340, at least one media file is selected from the set of candidate media files based at least in part upon on the assigned scores. The media file may be selected based entirely on the scores derived from Age Popularity Data of the retrieved media files and the Identified Age Group of the user. Alternatively, the media file may be selected based on the assigned scores in combination with other factors. For example, the media files may be organized based on the assigned scores combined with user taste data, user listening history data, user location data, or user environment data. In addition, the relative importance of the age score with respect to the other factors used in selection the media files is a variable that may be set, assigned, or derived.

In some preferred embodiments of the present invention, the relative importance of age as compared to other factors used in selection the media file is based in whole or in part upon a Age Correlation Factor value that is relationally associated with the user. In such embodiments the affect that age has upon media preference as compared to the affect that other factors have is dependent upon the Age Correlation Factor, the higher the Age Correlation Factor, the greater the affect that age has upon automatic media selection as compared to other factors used in selection.

Gender/Age Combinations: In some embodiments, both Gender and Age correlations may be used simultaneously to provide an even more refined selection of media files for a user of a particular age and gender combination. For example, for a MALE user of age group between 19 and 25 years old uses the automatic selection feature of the present invention. The user's Identified Age Group and Identified Gender is correlated with Age Popularity Information and Gender Popularity Information respectively to determine the level of match between a particular media file and the particular user. Age and Gender matches are a particular useful combination because user preference in media files are often highly correlated with the combined factors of age and gender. For example, MALE users between 8 and 12 years old have unique preferences and perspectives with respect to media that are very different from FEMALE users between 25 and 35 years old. Thus by considering a user's age and gender, better automatic media selections may be performed. This is especially true of specific taste profile information is not available for a user, for a user's tastes in media can often be predicted substantially based upon their age and gender.

Once a media file is selected from the plurality, it is suggested to and/or played to the user. If a suggestion is sent, the user may accept or reject. If accepted, the media will play to the user, either immediately or after one or more currently playing media files complete play. This may occur by a portable media player playing the media file from local memory. This may occur by the media player streaming the media over a communication link.

Additional Methods

Entering Data: As used herein, the software of the present invention must have access to an Identified Gender and/or an Identified Age Group of users for whom media is being automatically selected. This data may be collected at the time the media selection process is being performed or may be collected during a previous registration stage and stored with relational association to a user specific ID. Either way, the user may simply enter his or her gender by selecting a choice from a user interface or by responding to a query. Similarly the user may enter his or her age, birth year, birth date, or age group by selecting choices from a user interface or by responding to a query. Age grouping can then be derived from this data.

User Ratings: In addition to tracking how many and/or how often users of a particular GENDER or a particular AGE GROUP have listened to a given media file over a period of time, the invention disclosed herein includes further methods to allow said users to rate media, said ratings being correlated with the users Identified Gender data or Identified Age Group data. Said ratings can optionally be prompted by the media player of the user, asking the user to rate their personal partiality to the media file after it has been listened to by the user. The rating can be binary (favorable/unfavorable) or can be given on a continuous rating scale, for example a Partiality Rating Scale from 1 to 10 (1 being the lowest and 10 being the highest). In this way a user who is, for example, MALE and who listens to an automatically suggested media file, can rate the media file, that user's rating being added to the Gender Popularity Data store for that media file. Using the methods and systems disclosed herein, the Gender Popularity Data therefore indicates the popularity or partiality of each of a plurality of media files among users of a particular gender. Similarly, ratings may be stored in Age Popularity Data, correlating the ratings of media files with the age groupings of the users who provide the ratings.

Because the present invention includes a “suggestion” mode in which media files may be automatically suggested to a user, that user being given the option of accepting or rejecting, this act of accepting or rejecting may be used, at least in part, in the storage of user rating data. For example, if a user accepts a media file suggestion, positive rating data may be stored for that media file. Alternately if a user rejects a media file suggestion, negative rating data may be stored for that media file. In this way Age Popularity Data and Gender Popularity Data may be compiled, at least in part, based upon the acceptances and/or rejections of media files performed by user's of the system as correlated with those user's ages and/or genders. Thus the Gender Popularity Data, for example, may reflect the percentage of MALE users who accept a given media file when suggested to him as compared to the percentage of MALE users who reject that given media file. Similarly, Age Popularity Data, for example, may reflect the percentage of users with a particular age group who accept a given media file when suggested as compared to the percentage of users in that age group who reject that given media file.

Predicting the Gender of an unknown user: There are some situations wherein the system of the present invention may automatically suggest or play a media file to a user of unknown gender. For example, the user may have refused or neglected to enter gender data into the system. A benefit of the methods and apparatus of the present invention is that it provides a computational infrastructure within which the Gender of a user may be accurately predicted based upon previously collected Gender Popularity Data from other users and data reflecting the current and/or historical media file preferences of the current user of unknown gender. Using the methods and apparatus as disclosed herein, the gender of a user of unknown gender can be predicted by correlating the media files that he or she demonstrates partiality to, with the Gender Popularity Data for those media files. By “demonstrates partiality” it is meant that the user demonstrates that a particular media file is to his or her liking. This may be documented as a result of the user selecting the media file for play spontaneously. This may be documented as a result of the user providing favorable subjective rating data with respect to the media file. This may be documented as a result of the user accepting a suggestion of that media file from the automated suggestion routines of the present invention. In any of these ways, the user may indicate to the routines of the present invention that he or she is partial to one or more particular media files. This partiality can then be correlated with Gender Popularity Data for those media files. The correlation may be used to predict the gender of that unknown user.

For example, if a user has recently rated ten musical media files as being favorable, each of those media files having Gender Popularity Data showing a strong correlation with an Identified Gender of MALE, the software of the present invention may predict that the current user of unknown Gender is male.

Furthermore the software of the present invention may assign an Identified Gender to that unknown user of MALE. In this way the present invention may provide further selections and/or suggestions to that user based upon the prediction that he or she is male. If that user continues to accept the suggestions, the prediction is further corroborated. If that user rejects the suggestions, the prediction may be reevaluated based upon the updated correlations between the user's demonstrations of partiality and the stored Gender Popularity Data for related musical media files.

Predicting the Age of an unknown user: There are some situations wherein the system of the present invention may automatically suggest or play a media file to a user of unknown Age. For example, the user may have refused or neglected to enter Age data into the system. A benefit of the methods and apparatus of the present invention is that it provides a computational infrastructure within which the Age of a user may be predicted based upon previously collected Age Popularity Data from other users and data reflecting the current and/or historical media file preferences of the current user of unknown age. Using the methods and apparatus as disclosed herein, the age of a user can be predicted by correlating the media files that he or she demonstrates partiality to, with the Age Popularity Data for those media files. By “demonstrates partiality” it is meant that the user demonstrates that a particular media file is to his or her liking. This may be documented as a result of the user selecting the media file for play spontaneously. This may be documented as a result of the user providing favorable subjective rating data with respect to the media file. This may be documented as a result of the user accepting a suggestion of that media file from the automated suggestion routines of the present invention. In any of these ways, the user may indicate to the routines of the present invention that he or she is partial to one or more particular media files. This partiality can then be correlated with Age Popularity Data for those media files. The correlation may be used to predict the age of that unknown user.

For example, if a user has recently rated ten musical media files as being favorable, each of those media files having Age Popularity Data showing a strong correlation with an Identified Age Group of 12 to 15 years old, the software of the present invention may predict that the current user of unknown age is in the age group 12 to 15 years old.

Furthermore the software of the present invention may assign an Identified Age Group to that unknown user of 12 to 15 years old. In this way the present invention may provide further selections and/or suggestions to that user based upon the prediction that he or she is of a particular age group. If that user continues to accept the suggestions, the age prediction is further corroborated. If that user rejects the suggestions, the prediction may be reevaluated based upon the updated correlations between the user's demonstrations of partiality and the stored Age Popularity Data for related musical media files.

The foregoing described embodiments of the invention are provided as illustrations and descriptions. They are not intended to limit the invention to the precise forms described. In particular, it is contemplated that functional implementation of the invention described herein may be implemented equivalently in hardware, software, firmware, and/or other available functional components or building blocks. While the invention herein disclosed has been described by means of specific embodiments, examples and applications thereof, numerous modifications and variations could be made thereto by those skilled in the art without departing from the scope of the invention set forth in the claims.

What is claimed is:

1. A method of selecting a media file for play to a user comprising:
receiving an identified gender of a user;
identifying a plurality of candidate media files;
assigning each of the plurality of candidate media files a score based at least in part upon a correlation between gender popularity data associated with each of the plurality of candidate media files and the identified gender of the user; and
selecting the media file based at least in part upon the score.

2. The method of claim 1 wherein the identified gender of the user is denoted by a single variable.

3. The method of claim 1 wherein the selecting step is based at least in part upon a gender correlation factor indicative of a statistical relevance that gender has in selecting a user-preferred media file.

4. The method of claim 1 wherein the score is an absolute value on a scale.

5. The method of claim 1 wherein the score of each of the plurality of candidate media files is a value relative to the score of others of the plurality of candidate media files.

6. The method of claim 1 wherein the gender popularity data is maintained at a server.

7. The method of claim 1 wherein the identified gender of the user is maintained at a server or at a media player.

8. The method of claim 1 further comprising:
adjusting the score based upon a history of media file preferences of the user.

9. The method of claim 1 further comprising:
adjusting the score based upon a history of media file preferences of other users of the same gender as the user.

10. The method of claim 1 wherein the identified gender of the user is predicted based upon a history of media file selections of the user.

11. The method of claim 1 wherein the receiving the identified gender of the user comprises accessing a data file associated with the user.

12. A method of selecting a media file for play to a user comprising:
receiving an identified age of a user;
identifying a plurality of candidate media files;
assigning each of the plurality of candidate media files a score based at least in part upon a correlation between age popularity data associated with each of the plurality of candidate media files and the identified age of the user; and
selecting the media file based at least in part upon the score.

13. The method of claim 12 wherein the identified age group of the user is an indication of the annual age of the user or a range of annual ages.

14. The method of claim 12 wherein the selecting step is based at least in part upon an age correlation factor indicative of a statistical relevance that age has in selecting a user-preferred media file.

15. The method of claim 12 wherein the score is an absolute value on a scale.

16. The method of claim 12 wherein the score of each of the plurality of candidate media files is a value relative to the score of others of the plurality of candidate media files.

17. The method of claim 12 wherein the age popularity data is maintained at a server.

18. The method of claim 12 wherein the identified age of the user is maintained at a server or at a media player.

19. The method of claim 12 further comprising:
adjusting the score based upon a history of media file preferences of the user.

20. The method of claim 12 further comprising:
adjusting the score based upon a history of media file preferences of other users of the same age as the user.

21. The method of claim 12 wherein the identified age of the user is predicted based upon a history of media file selections of the user.

22. The method of claim 12 wherein the selecting step further comprises using a weighting factor that indicates the relative impact that the identified age has upon media file preference as compared to at least one other factor.

23. A method of selecting a media file for play to a user comprising:
receiving an identified age and an identified gender of a user;
identifying a plurality of candidate media files;
assigning each of the plurality of candidate media files a score based at least in part upon the identified age and the identified gender of the user; and
selecting the media file based at least in part upon the score.

24. The method of claim 23 wherein the assigning step further comprises using a weighting factor that affects the impact of the identified age upon the score as compared to the impact of the identified gender upon the score.

25. A device for selecting a musical song for play to a user comprising:
one or more processors adapted to:
receive a user characteristic of a user,
identify a plurality of candidate musical songs,
assign each of the plurality of candidate musical songs a score based at least in part upon a correlation between the user characteristic and characteristic-specific popularity data associated with each of the plurality of candidate songs, and
select the musical song from the plurality of candidate musical songs based at least in part upon the score.

26. The device of claim 25 wherein the user characteristic is the gender of the user.

27. The device of claim 25 wherein the user characteristic is the age of the user.

28. A method of predicting a gender of a user comprising:
receiving a history of media selections of a user;
determining a correlation between the history of the media selections of the user and gender popularity data associated with the media selections; and
predicting a gender of the user based at least in part upon the correlation.

29. The method of claim 28 further comprising:
selecting automatically future media for play to the user based at least in part upon the predicted gender of the user.

30. A method of predicting an age of a user comprising:
receiving a history of media selections of a user;
determining a correlation between the history of the media selections of the user and age popularity data associated with the media selections; and
predicting an age of the user based at least in part upon the correlation.

31. The method of claim 30 further comprising:
selecting automatically future media for play to the user based at least in part upon the predicted age of the user.
